(19) United States
(12) Patent Application Publication
(10) Pub. No.: US 2015/0055082 A1
(43) Pub. Date: Feb. 26, 2015

(54) Progressive Ophthalmic Surface

(71) Applicants: ESSILOR CANADA LTEE, Saint Laurent (CA); UNIVERSITE DE MONTREAL, Montreal (CA)

(72) Inventors: Jocelyn Faubert, Montreal (CA); Guillaume Giraudet, Montreal (CA)

(21) Appl. No.: 14/390,310

(22) PCT Filed: Apr. 2, 2013
(86) PCT No.: PCT/CA2013/050264

§ 371 Date: Oct. 2, 2014

(30) Foreign Application Priority Data
Apr. 2, 2012 (EP) 12305395.1

(51) Int. Cl. G02C 7/06; G02C 7/02

(52) U.S. Cl. CPC G02C 7/065; G02C 7/027
USPC 351/159.42; 351/159.74

(57) ABSTRACT

A progressive lens comprising a progressive ophthalmic surface including a main progression meridian dividing the surface into a nasal portion and a temporal portion and passing through at least one fitting point Py of ordinate Yp in a coordinate system centered on a reference point O(0; 0). For the points located at an ordinate Yp on either side of said fitting point Py, the points of ordinate Yp being contained inside a 50 mm diameter disc centered on the reference point O:

$$0.5 \geq \vert \frac{{MaxgradCyl}_{Ny 1} - {MaxgradCyl}_{Ty 1}}{{MaxgradCyl}_{Ny 1} + {MaxgradCyl}_{Ty 1}} \vert \geq 0.2$$

where:
MaxgradCylNy1 is the absolute value of the maximum cylinder gradient of all the points located at said ordinate Yp in the nasal portion of the surface; and
MaxgradCylTy1 is the absolute value of the maximum cylinder gradient of all the points located at said ordinate Yp in the temporal portion of the surface.

The present invention relates to a progressive lens comprising a progressive ophthalmic surface, to a pair of progressive lenses comprising progressive ophthalmic surfaces and to a method for defining such a pair.

Progressive lenses or progressive power lenses, also called progressive addition lenses, progressive ophthalmic lenses or varifocal or multifocal ophthalmic lenses, have been used for a long time to correct the ametropia of a wearer in a way adapted to both their distance vision and near vision. To do this, the lens has optical power values that are variable along a meridian line, between a reference direction for distance vision and a reference direction for near vision.

Therefore, progressive lenses conventionally comprise a distance vision zone, a near vision zone, an intermediate vision zone and a main progression meridian passing through these three zones. Document FR-A-2 699 294, to which the reader may refer for more details, describes, in its preamble, the various elements of a progressive ophthalmic lens (i.e. a progressive lens) and work carried out to improve the comfort of wearers of such lenses. To summarize, the zone referred to as the distance vision zone is the top portion of the lens, which portion is used by the wearer when looking into the distance. The zone referred to as the near vision zone is the bottom portion of the lens, this portion being used by the wearer to focus at short distances, for example in order to read. The zone extending between these two zones is referred to as the intermediate vision zone.

The values of the optical power for these two reference directions are determined from a prescription that is prepared for the wearer. Usually, the prescription indicates a value of the optical power for the distance vision and an addition value. The value of the optical power of the lens that is recommended for the wearer to correct their sight in the near vision field is equal to the sum of the optical power value that is prescribed for their distance vision and the prescribed addition value. The lens that is provided to the wearer is manufactured to produce substantially the value of the optical power that is thus calculated for their near vision and the value of the optical power that is prescribed for their distance vision, at the two reference directions for near vision and distance vision, respectively.

In practice, progressive lenses most often comprise an aspherical face and a spherical or toroidal face that is machined to match the lens to the prescription of the wearer. It is therefore conventional to characterize a progressive lens by the parameters of its aspherical surface, namely at any point a mean sphere S and a cylinder.

The mean sphere SPH is defined by the following formula:

$$SPH = \frac{n - 1}{2} ( \frac{1}{{R}_{1}} + \frac{1}{{R}_{2}} )$$

where R1 and R2 are the minimum and maximum radii of curvature, expressed in meters, and n the refractive index of the material of the lens.

In this case, the mean sphere gradient gradSPH is conventionally defined as the vector the coordinates of which along each axis are equal to the partial derivatives of the mean sphere along this axis, respectively, and, by misuse of language, the norm of the gradient vector is referred to as the gradient, i.e.:

$$gradSPH = ‖ \vec{gradSPH} ‖ = \sqrt{{( \frac{\partial SPH}{\partial x} )}^{2} + {( \frac{\partial SPH}{\partial y} )}^{2}}$$

The cylinder is given, following the same conventions, by the formula:

$$CYL = \frac{n - 1}{2} \vert \frac{1}{{R}_{1}} - \frac{1}{{R}_{2}} \vert$$

In this case, the cylinder gradient gradCYL is conventionally defined as the vector the coordinates of which along each axis are equal to the partial derivatives of the cylinder along this axis, respectively, and, by misuse of language, the norm of the gradient vector is referred to as the gradient, i.e.:

$$gradCYL = ‖ \vec{gradCYL} ‖ = \sqrt{{( \frac{\partial CYL}{\partial x} )}^{2} + {( \frac{\partial CYL}{\partial y} )}^{2}}$$

The main progression meridian is the term used to refer to a line that is generally defined as the intersection of the aspherical surface of the lens and the gaze of the wearer when he or she is looking forwards, at various distances. The main progression meridian is often an umbilic line, i.e. a line all the points of which have a cylinder of zero.

The aspherical surface of the lens comprises two distinct zones, the first dedicated to distance vision, and the second dedicated to near vision, and a third zone dedicated to intermediate vision extending between the two first zones.

It has been suggested to tailor the distribution of unwanted astigmatism depending on the propensity of the wearer to turn horizontally rather their head or their eyes when they look in succession in two different directions located at a given height. Such tailoring of the design of the progressive lens allows the discomfort caused to the wearer by unwanted astigmatism to be decreased. This is therefore a personalization of the progressive lens depending on the wearer, which is supplementary to the machining of the lens to the optical prescription that is prepared for the wearer.

It is also known to adapt a progressive lens depending on vertical movements of the head of the wearer. This is another personalization of the progressive lens, which is different from the preceding one and is based on horizontal cephalic movements. Such a personalization, which takes into account changes in the inclination of the head in a vertical plane, is intended to adjust the variation of the optical power of the progressive lens along the meridian line. In this way, the optical power is adapted to the distance of the object whatever the angular height of the direction in which the object is found in front of the wearer. For this purpose, document EP 1 591 064 for example provides a device that allows variations in the inclination of the head of the wearer to be determined when he or she looks alternatively in the reference direction for distance vision and that for near vision.

However, methods for personalizing a progressive lens that have been provided before the present invention, to take into account movements of the head of the wearer, were carried out under the assumption that the wearers had a symmetric eye/head coordination.

In other words, it has always been assumed that the propensity of an individual to move their head or their eyes when they look in succession in two separate directions is the same whether the second direction is on the left-hand side or on the right-hand side of the reference direction.

However, the inventors have observed that the eye/head coordination of certain individuals may be asymmetric.

Present-day progressive lenses have surfaces that are as symmetric as possible about the meridian.

Thus, present-day progressive lenses do not take into account any asymmetry in the propensity of an individual to move their head or their eyes to look at an object.

There is therefore a need for progressive lenses comprising a progressive ophthalmic surface making it possible to take these asymmetries into account.

The object of the invention is to provide a progressive lens comprising a progressive ophthalmic surface allowing the asymmetry of the needs of the wearer to be taken into account.

Document WO 2012/004783 discloses a lens comprising a progressive surface having a power map that is asymmetric about the main meridian of the surface of the lens. However, this type of lens is not entirely satisfactory and does not allow the ophthalmic lenses to be rapidly tailored to the wearer.

For this purpose, the invention provides a progressive lens comprising a progressive ophthalmic surface including a main progression meridian dividing the surface into a nasal portion and a temporal portion and passing through at least one fitting point P_{y} of ordinate Yp in a coordinate system centered on a reference point O(0; 0), in which for the points located at the ordinate Yp on either side of said point Py, the points of ordinate Yp being contained inside a 50 mm diameter disc centered on the reference point O:

$$0.5 \geq \vert \frac{{MaxgradCyl}_{Ny 1} - {MaxgradCyl}_{Ty 1}}{{MaxgradCyl}_{Ny 1} + {MaxgradCyl}_{Ty 1}} \vert \geq 0.2$$

where:

MaxgradCyl_{Ny1} is the absolute value of the maximum cylinder gradient of all the points located at said ordinate Yp in the nasal portion of the surface, the ordinate points Yp being contained inside the 50 mm diameter disc centered on the reference point O; and

MaxgradCyl_{Ty1} is the absolute value of the maximum cylinder gradient of all the points located at said ordinate Yp in the temporal portion of the surface, the ordinate points Yp being contained inside the 50 mm diameter disc centered on the reference point O.

Control of the cylinder gradients makes it possible to improve the comfort of dynamic vision when the progressive lens wearer moves their head and their eyes.

Advantageously, the progressive ophthalmic surface according to the invention exhibits an asymmetry in the distribution of the cylinder gradients between the nasal portion and the temporal portion. This asymmetry makes it possible to take into account an asymmetry in the behavior of the wearer in their propensity to move their head or their eyes to look at an object.

A progressive lens comprising a progressive ophthalmic surface according to the invention may furthermore have one or more of the following optional features, considered individually or in any possible combination:
for all the points located at an ordinate Yp on either side of said point P_{Y}, the following relationship is respected:

$$0.4 \geq \vert \frac{{MaxgradCyl}_{Ny 1} - {MaxgradCyl}_{Ty 1}}{{MaxgradCyl}_{Ny 1} + {MaxgradCyl}_{Ty 1}} \vert$$

for all the points located at an ordinate Yp on either side of said point P_{Y}, the following relationship is respected:

$$0.35 \geq \vert \frac{{MaxgradCyl}_{Ny 1} - {MaxgradCyl}_{Ty 1}}{{MaxgradCyl}_{Ny 1} + {MaxgradCyl}_{Ty 1}} \vert$$

for all the points located at an ordinate Yp on either side of said point P_{Y}, the following relationship is respected:

$$\vert \frac{{MaxgradCyl}_{Ny 1} - {MaxgradCyl}_{Ty 1}}{{MaxgradCyl}_{Ny 1} + {MaxgradCyl}_{Ty 1}} \vert \geq 0.25$$

the surface comprises a visual zone intended for distance vision, said fitting point P_{Y} being a distance vision fitting point;
the surface comprises a visual zone intended for near vision, said fitting point P_{Y} being a near vision fitting point;
for all the points located at an ordinate Yp on either side of said point P_{Y}, the following relationship is respected:

$$0.5 \geq \vert \frac{{MaxgradSph}_{Ny 1} - {MaxgradSph}_{Ty 1}}{{MaxgradSph}_{Ny 1} + {MaxgradSph}_{Ty 1}} \vert \geq 0.2$$

where:
MaxgradSph_{Ny1} is the absolute value of the maximum sphere gradient of all the points located at said ordinate Yp in the nasal portion of the surface; and
MaxgradSph_{Ty1} is the absolute value of the maximum sphere gradient of all the points located at said ordinate Yp in the temporal portion of the surface;
for the points located at an ordinate Yp on either side of said point P_{Y}, the following relationship is respected:

$$0.4 \geq \vert \frac{{MaxgradSph}_{Ny 1} - {MaxgradSph}_{Ty 1}}{{MaxgradSph}_{Ny 1} + {MaxgradSph}_{Ty 1}} \vert ;$$

for all the points located at an ordinate Yp on either side of said point P_{Y}, the following relationship is respected:

$$0.35 \geq \vert \frac{{MaxgradSph}_{Ny 1} - {MaxgradSph}_{Ty 1}}{{MaxgradSph}_{Ny 1} + {MaxgradSph}_{Ty 1}} \vert ;$$

for all the points located at an ordinate Yp on either side of said point P_{Y}, the following relationship is respected:

$$\vert \frac{{MaxgradSph}_{Ny 1} - {MaxgradSph}_{Ty 1}}{{MaxgradSph}_{Ny 1} + {MaxgradSph}_{Ty 1}} \vert \geq 0.25 .$$

Control of the sphere gradients, like the cylinder gradients, makes it possible to improve the comfort of dynamic vision when the progressive lens wearer moves their head and their eyes.

The invention also relates to a pair of progressive lenses comprising progressive surfaces including a first lens comprising a first progressive surface intended for a right eye of a wearer and a second lens comprising a second progressive surface intended for a left eye of a wearer, the first and second lenses being according to the invention and for all the points located at an ordinate Yp on either side of the point Py of each of the progressive surfaces, the points of ordinate Yp being contained inside a 50 mm diameter disc centered on the reference point O:

$$\vert \frac{{MaxgradCyl}_{Ny 1} - {MaxgradCyl}_{Ty 2}}{{MaxgradCyl}_{Ny 1} + {MaxgradCyl}_{Ty 2}} \vert \leq 0.1 and , \\ \vert \frac{{MaxgradCyl}_{Ny 2} - {MaxgradCyl}_{Ty 1}}{{MaxgradCyl}_{Ny 2} + {MaxgradCyl}_{Ty 1}} \vert \leq 0.1$$

where:
maxgradCyl_{Ny1} is the absolute value of the maximum cylinder gradient of all the points located at said ordinate Yp in the nasal portion of the first surface;
MaxgradCyl_{Ty1} is the absolute value of the maximum cylinder gradient of all the points located at said ordinate Yp in the temporal portion of the first surface;
MaxgradCyl_{Ny2} is the absolute value of the maximum cylinder gradient of all the points located at said ordinate Yp in the nasal portion of the second surface; and
MaxgradCyl_{Ty2} is the absolute value of the maximum cylinder gradient of all the points located at said ordinate Yp in the temporal portion of the second surface.

According to one embodiment of the invention, for all the points located at an ordinate Yp on either side of the point P_{Y} of each of the progressive surfaces, the following relationships are respected:

$$\vert \frac{{MaxgradCyl}_{Ny 1} - {MaxgradCyl}_{Ty 2}}{{MaxgradCyl}_{Ny 1} + {MaxgradCyl}_{Ty 2}} \vert \leq 0.075 and , \\ \vert \frac{{MaxgradCyl}_{Ny 2} - {MaxgradCyl}_{Ty 1}}{{MaxgradCyl}_{Ny 2} + {MaxgradCyl}_{Ty 1}} \vert \leq 0.075 .$$

According to one embodiment of the invention, for all the points located at an ordinate Yp on either side of the point P_{Y} of each of the progressive surfaces, the following relationships are respected:

$$\vert \frac{{MaxgradCyl}_{Ny 1} - {MaxgradCyl}_{Ty 2}}{{MaxgradCyl}_{Ny 1} + {MaxgradCyl}_{Ty 2}} \vert \leq 0.05 and , \vert \frac{{MaxgradCyl}_{Ny 2} - {MaxgradCyl}_{Ty 1}}{{MaxgradCyl}_{Ny 2} + {MaxgradCyl}_{Ty 1}} \vert \leq 0.05 .$$

According to one embodiment, the pair of progressive lenses comprising progressive surfaces according to the invention may also include, for which for all the points located at an ordinate Yp on either side of said point P_{Y}, the following relationships are respected:

$$\vert \frac{{MaxgradSph}_{Ny 1} - {MaxgradSph}_{Ty 2}}{{MaxgradSph}_{Ny 1} + {MaxgradSph}_{Ty 2}} \vert \leq 0.1$$

$$\vert \frac{{MaxgradSph}_{Ny 2} - {MaxgradSph}_{Ty 1}}{{MaxgradSph}_{Ny 2} + {MaxgradSph}_{Ty 1}} \vert \leq 0.1$$

where:
MaxgradSph_{Ny1} is the absolute value of the maximum sphere gradient of all the points located at the ordinate Yp in the nasal portion of the first surface;
MaxgradSph_{Ty1} is the absolute value of the maximum sphere gradient of all the points located at the ordinate Yp in the temporal portion of the first surface;
MaxgradSph_{Ny2} is the absolute value of the maximum sphere gradient of all the points located at the ordinate Yp in the nasal portion of the second surface; and
MaxgradSph_{Ty2} is the absolute value of the maximum sphere gradient of all the points located at the ordinate Yp in the temporal portion of the second surface.

According to one embodiment of the invention, for all the points located at an ordinate Yp on either side of the point P_{Y} of each of the progressive surfaces, the following relationships are respected:

$$\vert \frac{{MaxgradSph}_{Ny 1} - {MaxgradSph}_{Ty 2}}{{MaxgradSph}_{Ny 1} + {MaxgradSph}_{Ty 2}} \vert \leq 0.075 , and$$

$$\vert \frac{{MaxgradSph}_{Ny 2} - {MaxgradSph}_{Ty 1}}{{MaxgradSph}_{Ny 2} + {MaxgradSph}_{Ty 1}} \vert \leq 0.075 .$$

According to one embodiment of the invention, for all the points located at an ordinate Yp on either side of the point P_{Y} of each of the progressive surfaces, the following relationships are respected:

$$\vert \frac{{MaxgradSph}_{Ny 1} - {MaxgradSph}_{Ty 2}}{{MaxgradSph}_{Ny 1} + {MaxgradSph}_{Ty 2}} \vert \leq 0.05 , and$$

$$\vert \frac{{MaxgradSph}_{Ny 2} - {MaxgradSph}_{Ty 1}}{{MaxgradSph}_{Ny 2} + {MaxgradSph}_{Ty 1}} \vert \leq 0.05 .$$

The invention also relates to a method for defining a pair of progressive lenses comprising progressive ophthalmic surfaces including a first lens comprising a first progressive surface, the first lens being intended for a right eye of a wearer and a second lens comprising a second progressive surface, the second lens being intended for a left eye of a wearer, the method comprising:
a step of providing the prescription, in which the prescription of a wearer is provided;
a step of providing eye/head coefficients, in which the right and left eye/head coefficients of the wearer are provided;
a step of defining a pair of progressive ophthalmic surfaces, in which a pair of progressive ophthalmic surfaces according to the invention is defined depending on the prescription of the wearer and the values of

$$\vert \frac{{MaxgradCyl}_{Ny 1} - {MaxgradCyl}_{Ty 1}}{{MaxgradCyl}_{Ny 1} + {MaxgradCyl}_{Ty 2}} \vert and$$

$$\vert \frac{{MaxgradCyl}_{Ny 2} - {MaxgradCyl}_{Ty 2}}{{MaxgradCyl}_{Ny 2} + {MaxgradCyl}_{Ty 2}} \vert$$

where

MaxgradCyl_{Ny1} and MaxgradCyl_{Ny2} the absolute values of the maximum cylinder gradient of all the points located at said ordinate Yp in the nasal portion of the first and second surfaces, respectively, and

MaxgradCyl_{Ty1} and MaxgradCyl_{Ty2} the absolute values of the maximum cylinder gradient of all the points located at said ordinate Yp in the temporal portion of the first and second surfaces, respectively,
are set depending on the right and left eye/head coefficients of the wearer.

The invention also relates to a method for defining a pair of progressive lenses comprising progressive ophthalmic surfaces including a first progressive surface intended for a right eye of a wearer and a second progressive surface intended for a left eye of a wearer, the method comprising:
a step of providing the prescription, in which the prescription of a wearer is provided;
a step of providing the span, in which the perceptual span of the wearer is provided;
a step of defining a pair of progressive lenses comprising progressive ophthalmic surfaces, in which a pair of progressive lenses comprising progressive ophthalmic surfaces according to the invention is defined depending on the prescription of the wearer and the values of

$$\vert \frac{{MaxgradCyl}_{Ny 1} - {MaxgradCyl}_{Ty 1}}{{MaxgradCyl}_{Ny 1} + {MaxgradCyl}_{Ty 2}} \vert and$$

$$\vert \frac{{MaxgradCyl}_{Ny 2} - {MaxgradCyl}_{Ty 2}}{{MaxgradCyl}_{Ny 2} + {MaxgradCyl}_{Ty 2}} \vert$$

where

MaxgradCyl_{Ny1} and MaxgradCyl_{Ny2} the absolute values of the maximum cylinder gradient of all the points located at said ordinate Yp in the nasal portion of the first and second surfaces, respectively, and

MaxgradCyl_{Ty1} and MaxgradCyl_{Ty2} the absolute values of the maximum cylinder gradient of all the points located at said ordinate Yp in the temporal portion of the first and second surfaces, respectively, are set depending on the perceptual span of the wearer.

The invention also relates to a method for obtaining a piece of ophthalmic equipment comprising a pair of progressive lenses comprising progressive ophthalmic surfaces forming a right lens and a left lens, the method involving using the pair of progressive lenses comprising progressive surfaces according to the invention to define the optical function of a right target lens and to define the optical function of a left target lens.

The invention furthermore relates to a piece of ophthalmic equipment comprising a pair of progressive lenses comprising progressive ophthalmic surfaces, said piece of equipment being obtained according to the invention.

Another object of the invention is a computer software package comprising a series of instructions that when loaded into a computer lead to the execution, for example by said computer, of the steps of a method according to the invention.

In the context of the invention, the term “lens” or “ophthalmic lens” is understood to mean a lens intended to be fitted into a frame and any model lens used in procedures for optimizing the optical function of a lens intended to be fitted in a frame.

The invention will be more clearly understood from reading the following description, which is given merely by way of example and with reference to the appended drawings, in which:

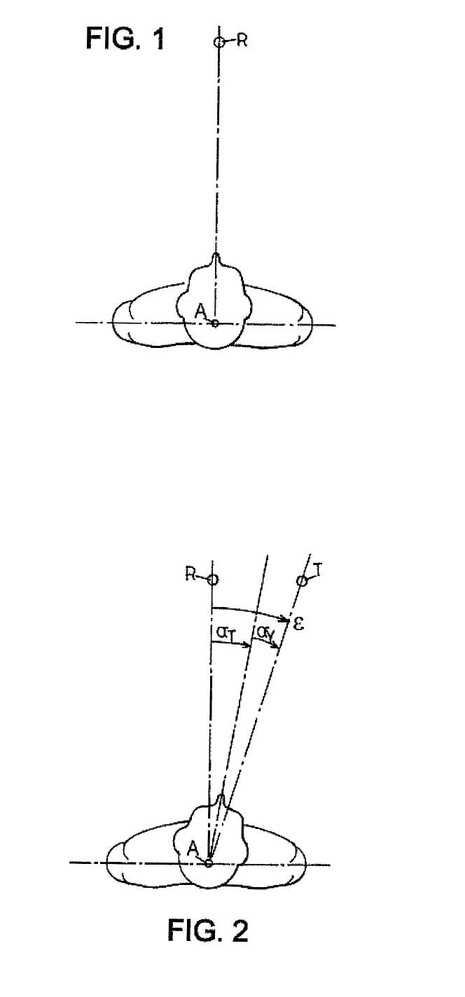

FIGS. 1 and 2 show an example measurement of an eye/head coefficient of a wearer;

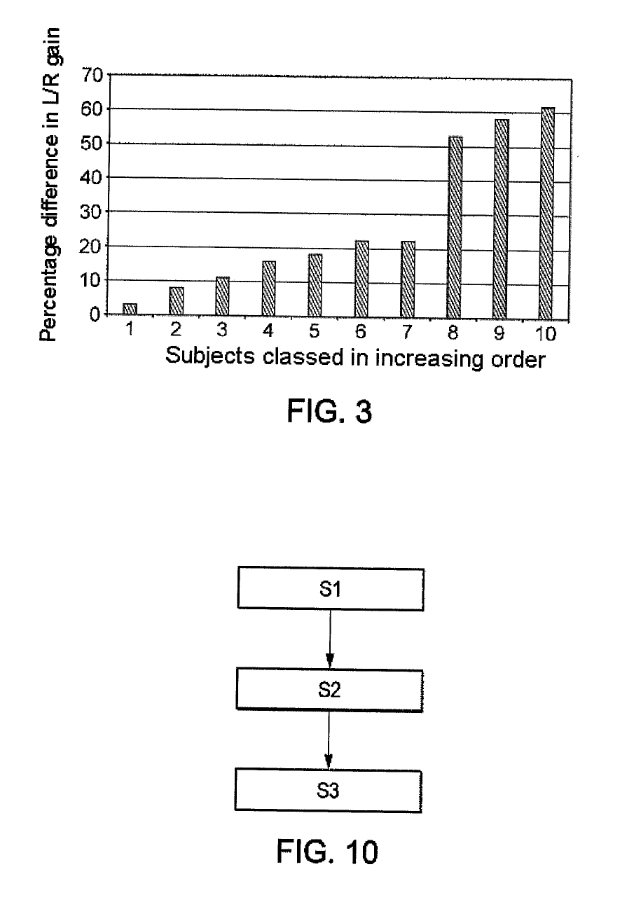

FIG. 3 shows the proportions of wearers having a different left- and right-hand side eye/head coefficient;

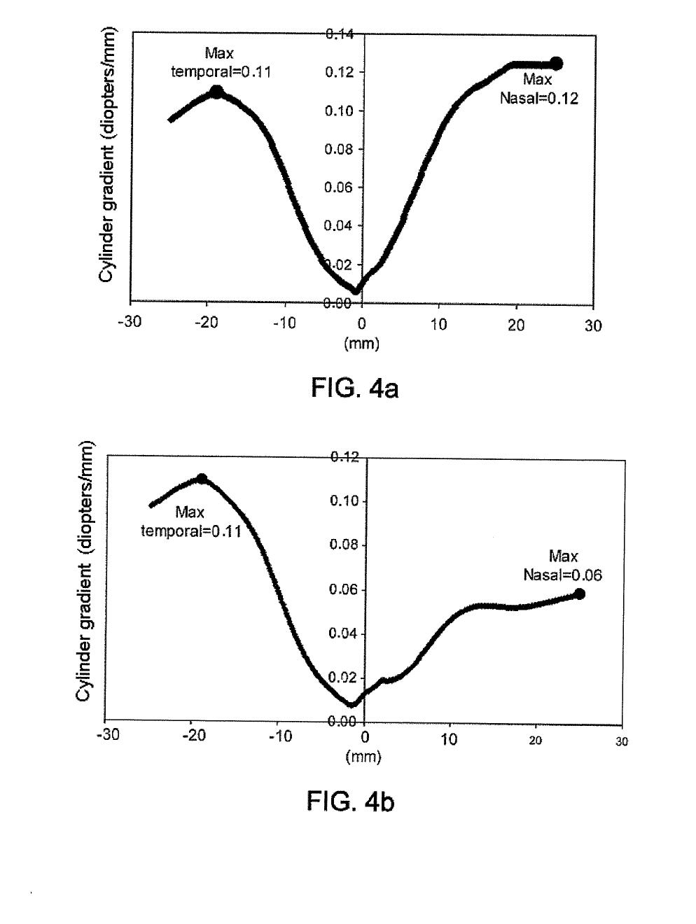

FIGS. 4a and 4b show the distance vision cylinder gradient for a known lens and a lens according to the invention, respectively;

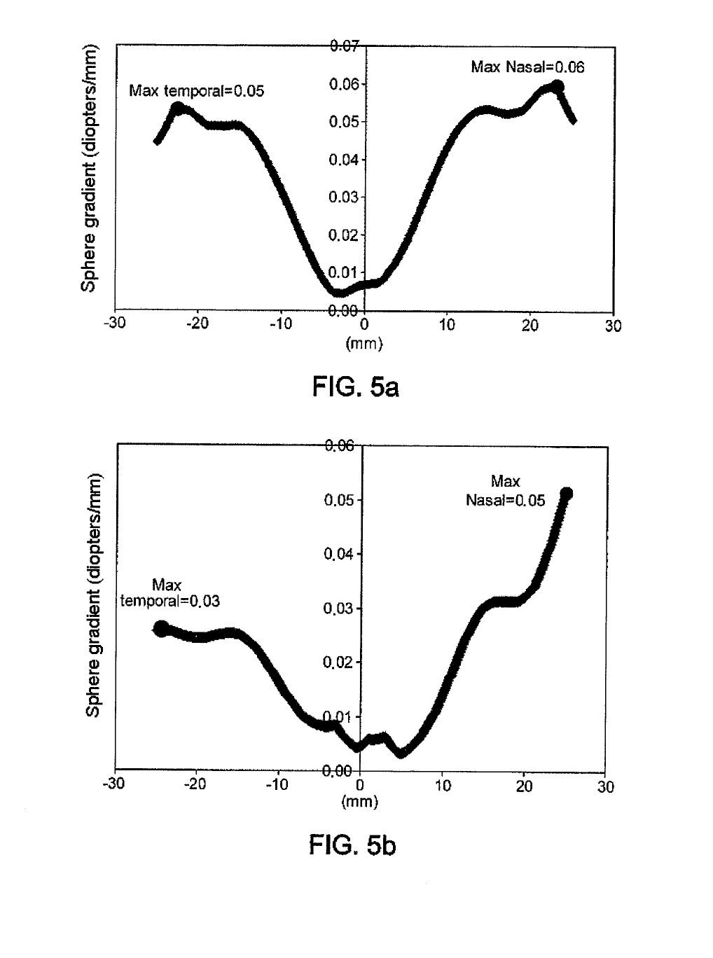

FIGS. 5a and 5b show the distance vision sphere gradient for a known lens and a lens according to the invention, respectively;

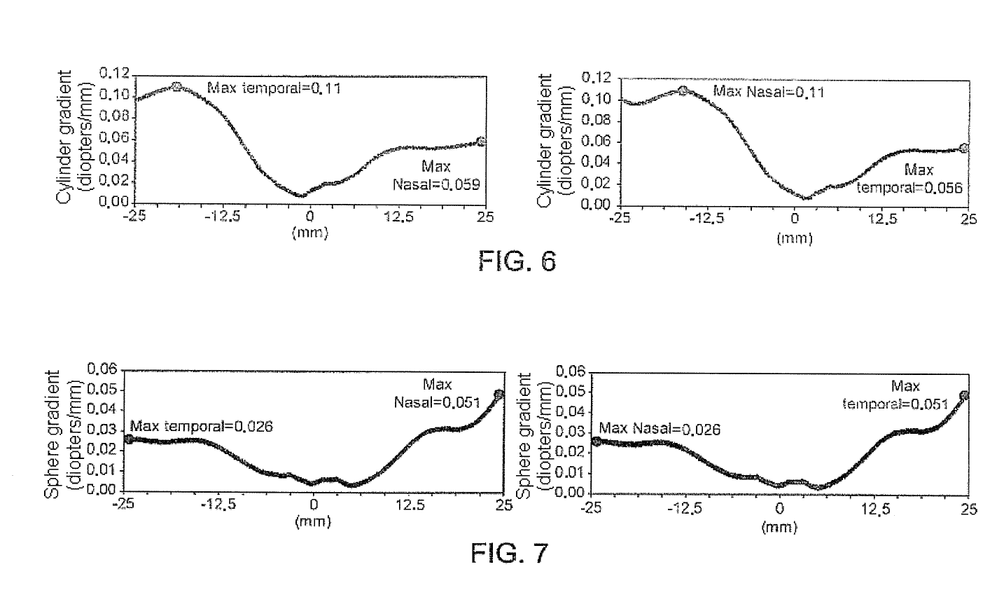

FIG. 6 shows the distance vision cylinder gradient of a pair of lenses according to the invention;

FIG. 7 shows the distance vision sphere gradient of a pair of lenses according to the invention;

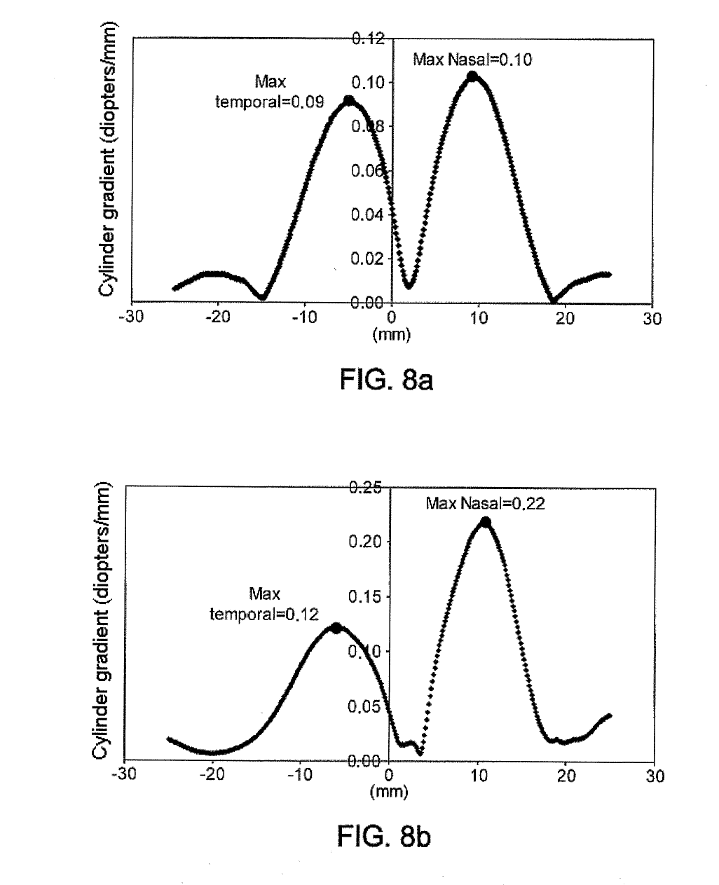

FIGS. 8a and 8b show the near vision cylinder gradient for a known lens and a lens according to the invention, respectively;

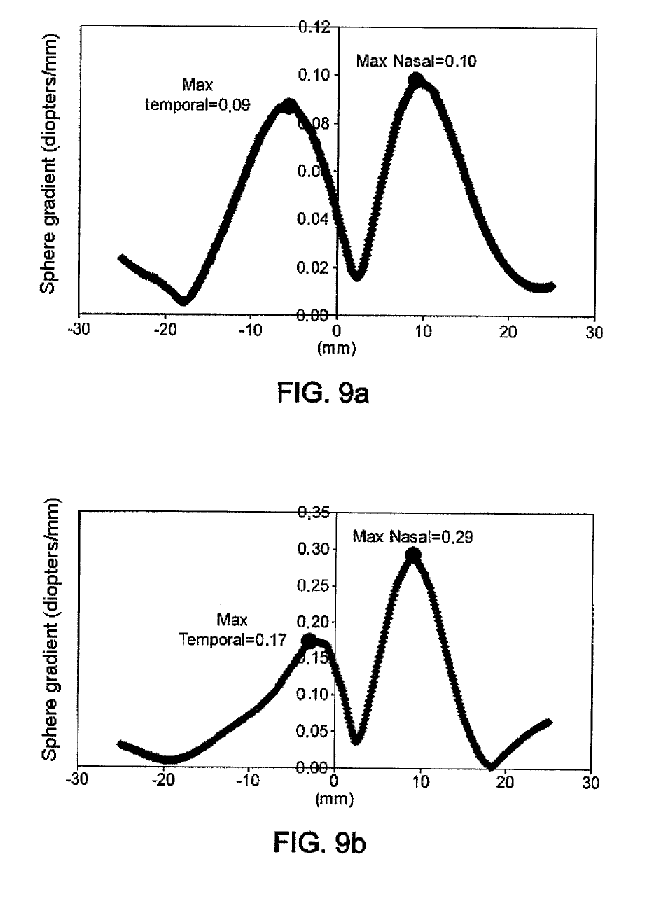

FIGS. 9a and 9b show the near vision cylinder gradient for a known pair of lenses and a pair of lenses according to the invention, respectively; and

FIG. 10 shows a method according to the invention.

For the sake of clarity, the various elements shown in the figures are not necessarily to scale.

To characterize the propensity of a person who wears ophthalmic spectacle lenses to move their head or their eyes to follow a target with their gaze, the relative amplitudes of the movement of the eyes and head of the wearer are measured. To do this, the wearer may be asked to look at a first target located in the sagittal plane of the wearer, said target being referred to as the reference target, while placed facing the latter. The expression “sagittal plane of a wearer” is understood to mean the plane midway between the two eyes of the wearer. The reference target is designated R in FIG. 1. The wearer places themselves in front of the reference target, with their shoulders located substantially in a vertical plane perpendicular to the virtual line that connects their head to the reference target. He or she then has their head and eyes oriented in the direction of the reference target.

From this situation, the wearer is asked to look at a second target, referred to as the test target and designated T, that is offset relative to the reference target, without moving their shoulders. To do this, the wearer turns in part their head and in part their eyes (FIG. 2), so that the direction of their gaze passes from the reference target R to the test target T.

Preferably, the test target is offset horizontally relative to the reference target, so as to characterize the horizontal movements of the head and eyes of the wearer.

The angular offset of the test target relative to that of the reference target is called the radial deviation, and designated E. The center of the head A of the wearer is taken as the center point of measurement of the angles in a horizontal plane that contains this center point and the two targets R and T.

In FIG. 2, αT designates the angle through which the head of the wearer rotates, also called the angular deviation of the head, to pass from the first situation of observation of the reference target to the second situation of observation of the test target. αY is the angle of rotation of the eyes, this rotation being carried out simultaneously by the wearer.

The radial deviation E is therefore equal to the sum of the two angles αT and αY.

The quotient of the angular deviation of the head αT divided by the radial deviation E is then calculated.

This quotient is equal to one for a wearer who only turns their head to pass from the reference target to the test target, and to zero for a wearer who turns only their eyes.

Next, a gain G is calculated for this “eye/head” movement coordination test that was performed by the wearer. The gain G may be defined as a preset increasing function of the quotient of the angular deviation of the head αT divided by the radial deviation E.

For example, the gain G may be directly equal to the quotient of αT divided by E: G=αT/E.

A wearer that turns essentially their eyes to focus on the test target therefore obtains a value of almost zero for the gain G, and a wearer that essentially turns their head to focus on the same target obtains a G value of almost one.

This type of testing method does not take into account possible wearer asymmetry.

For distance vision, for example, the inventors have observed the proportion of the movement made by the head to look at a target at 40 degrees may be different depending on whether the target is located to the right or left of the central fixation point.

This left-right symmetry/asymmetry varies from one individual to another, as illustrated in the graph in FIG. 3.

The graph in FIG. 3 collates the results of measurements carried out by the inventors. These measurements were carried out on a group of 10 presbyopic individuals who were asked to look at test targets located at 40 degrees on either side of a reference target. The inventors have collated in the graph in FIG. 3, differences in gain when the test target is located on the left or right of the wearer.

The graph in FIG. 3 illustrates that among the 10 presbyopic wearers tested, some exhibited a relatively high symmetry of rotation of the head on the 2 sides of the field whereas for others, the difference of involvement of the head in the movement of the gaze toward the peripheral target may reach as high as 60%.

Thus, it should appear obvious that an asymmetry may exist in the “eye/head” coefficient of a wearer.

During the design of present-day progressive lens surfaces, at best a mean “eye/head” coefficient is taken into account, namely a mean of the coefficient measured on the left- and right-hand sides.

Thus, the surfaces of progressive lenses are generally highly symmetric about the main meridian.

A progressive ophthalmic surface includes a main progression meridian dividing the surface into a nasal portion and a temporal portion and passing through at least one fitting point P_{y} of ordinate Yp in a coordinate system centered on a reference point O(0; 0).

The progressive surfaces of progressive lenses according to the invention are asymmetric about the main progression meridian.

For example, if the wearer exhibits a distance vision eye/head coefficient asymmetry, the progressive ophthalmic surface according to the invention is shaped so that points located at an ordinate Yp on either side of the distance vision fitting point (also called the distance visual point), respect:

$$0.5 \geq \vert \frac{{MaxgradCyl}_{Ny 1} - {MaxgradCyl}_{Ty 1}}{{MaxgradCyl}_{Ny 1} + {MaxgradCyl}_{Ty 1}} \vert \geq 0.2$$

where:

MaxgradCyl_{Ny1} is the absolute value of the maximum cylinder gradient of all the points located at said ordinate Yp in the nasal portion of the surface—in other words, MaxgradCyl_{Ny1} is the absolute value of the maximum cylinder gradient of all the nasal-side points having the same single ordinate Yp; and

MaxgradCyl_{Ty1} is the absolute value of the maximum cylinder gradient of points of the surface at said ordinate Yp in the temporal portion of the surface—in other words, MaxgradCyl_{Ty1} is the absolute value of the maximum cylinder gradient of all the temporal-side points having the same single ordinate Yp, the ordinate points Yp being comprised inside the 50 mm diameter disc centered on the reference point O.

FIGS. 4a and 4b show cylinder gradient values for points located on either side of the distance visual point for a lens comprising a prior-art ophthalmic surface and a lens comprising an ophthalmic surface according to the invention, respectively.

As illustrated in FIG. 4a, the lens comprising the prior-art ophthalmic surface has a cylinder gradient profile that is symmetric about the distance visual point, and for points located at an ordinate Yp on either side of the distance visual point:

$$0.07 \geq \vert \frac{{MaxgradCyl}_{Ny 1} - {MaxgradCyl}_{Ty 1}}{{MaxgradCyl}_{Ny 1} + {MaxgradCyl}_{Ty 1}} \vert .$$

Thus, lenses comprising the prior-art ophthalmic surfaces are poorly suited to wearers that have asymmetric “eye/head” coefficients.

As illustrated in FIG. 4b, the progressive ophthalmic surface according to the invention exhibits an asymmetry in the distribution of the cylinder gradient between the nasal and temporal portions.

The surface illustrated in FIG. 4b exhibits, for points located at an ordinate Yp on either side of the distance visual point, a contrast in cylinder gradient

$$\vert \frac{{MaxgradCyl}_{Ny 1} - {MaxgradCyl}_{Ty 1}}{{MaxgradCyl}_{Ny 1} + {MaxgradCyl}_{Ty 1}} \vert$$

equal to 0.30.

Thus, the cylinder gradient distribution on either side of the distance visual point is asymmetric, making it possible to more rapidly tailor the ophthalmic lenses to a wearer and to increase subjective satisfaction relative to existing lenses.

FIGS. 5a and 5b show sphere gradient values for points located on either side of the distance visual point for a lens comprising a prior-art ophthalmic surface and a lens comprising an ophthalmic surface according to the invention, respectively.

As illustrated in FIG. 5a, the lens comprising the prior-art ophthalmic surface has a sphere gradient profile that is symmetric about the distance visual point, and for points located at an ordinate Yp on either side of the distance visual point:

$$0.06 \geq \vert \frac{{MaxgradSph}_{Ny 1} - {MaxgradSph}_{Ty 1}}{{MaxgradSph}_{Ny 1} + {MaxgradSph}_{Ty 1}} \vert .$$

Thus, lenses comprising the prior-art ophthalmic surfaces are poorly suited to wearers that have asymmetric “eye/head” coefficients.

As illustrated in FIG. 5b, the progressive ophthalmic surface according to the invention exhibits an asymmetry in the distribution of the sphere gradient between the nasal and temporal portions.

The surface illustrated in FIG. 5b exhibits, for points located at an ordinate Yp on either side of the distance visual point, a contrast in sphere gradient

$$\vert \frac{{MaxgradSph}_{Ny 1} - {MaxgradSph}_{Ty 1}}{{MaxgradSph}_{Ny 1} + {MaxgradSph}_{Ty 1}} \vert$$

equal to 0.33.

Thus, the sphere gradient distribution on either side of the distance visual point is asymmetric, making it possible to more rapidly tailor the ophthalmic lenses to a wearer and to increase subjective satisfaction relative to existing lenses.

The invention also relates to a pair of progressive lenses comprising progressive surfaces including a first progressive surface intended for a right eye of a wearer and a second progressive surface intended for a left eye of a wearer. The first and second surfaces are according to the invention, and for the points located at an ordinate Yp on either side of the point P_{Y} of each of the progressive surfaces:

$$\vert \frac{{MaxgradCyl}_{Ny 1} - {MaxgradCyl}_{Ty 2}}{{MaxgradCyl}_{Ny 1} + {MaxgradCyl}_{Ty 2}} \vert \leq 0.1 and , \\ \vert \frac{{MaxgradCyl}_{Ny 2} - {MaxgradCyl}_{Ty 1}}{{MaxgradCyl}_{Ny 2} + {MaxgradCyl}_{Ty 1}} \vert \leq 0.1$$

where
MaxgradCyl_{Ny1} is the absolute value of the maximum cylinder gradient of all the points located at said ordinate Yp in the nasal portion of the first surface;
MaxgradCyl_{Ty1} is the absolute value of the maximum cylinder gradient of all the points located at said ordinate Yp in the temporal portion of the first surface;
MaxgradCyl_{Ny2} is the absolute value of the maximum cylinder gradient of all the points located at said ordinate Yp in the nasal portion of the second surface; and
MaxgradCyl_{Ty2} is the absolute value of the maximum cylinder gradient of all the points located at said ordinate Yp in the temporal portion of the second surface.

FIG. 6 shows cylinder gradient values for points located on either side of the distance visual point for a pair of lenses comprising ophthalmic surfaces according to the invention, respectively.

As illustrated in FIG. 6, the nasal portion of the first surface has a maximum cylinder gradient similar to the maximum cylinder gradient of the temporal portion of the second surface, and the temporal portion of the first surface has a maximum cylinder gradient similar to the maximum cylinder gradient of the nasal portion of the second surface.

According to one embodiment of the invention, the nasal portion of the first surface has a maximum sphere gradient similar to the maximum sphere gradient of the temporal portion of the second surface, and the temporal portion of the first surface has a maximum cylinder gradient similar to the maximum cylinder gradient of the nasal portion of the second surface.

In other words, the points located at an ordinate Yp on either side of said distance visual point respect:

$$\vert \frac{{MaxgradSph}_{Ny 1} - {MaxgradSph}_{Ty 2}}{{MaxgradSph}_{Ny 1} + {MaxgradSph}_{Ty 2}} \vert \leq 0.1$$

$$\vert \frac{{MaxgradSph}_{Ny 2} - {MaxgradSph}_{Ty 1}}{{MaxgradSph}_{Ny 2} + {MaxgradSph}_{Ty 1}} \vert \leq 0.1$$

where
MaxgradSph_{NY1} is the absolute value of the maximum sphere gradient of all the points located at the ordinate Yp in the nasal portion of the first surface;
MaxgradSph_{Ty1} is the absolute value of the maximum sphere gradient of all the points located at the ordinate Yp in the temporal portion of the first surface;
MaxgradSph_{Ny2} is the absolute value of the maximum sphere gradient of all the points located at the ordinate Yp in the nasal portion of the second surface; and
MaxgradSph_{Ty2} is the absolute value of the maximum sphere gradient of all the points located at the ordinate Yp in the temporal portion of the second surface.

FIG. 7 shows sphere gradient values for points located on either side of the distance visual point for a pair of lenses comprising ophthalmic surfaces according to the invention, respectively.

As illustrated in FIG. 7, the nasal portion of the first surface has a maximum sphere gradient similar to the maximum sphere gradient of the temporal portion of the second surface, and the temporal portion of the first surface has a maximum sphere gradient similar to the maximum sphere gradient of the nasal portion of the second surface.

The near vision visual field may also be asymmetric.

For example, a reading task may introduce a visual asymmetry located to the right of the point of ocular fixation. Studies (see Rayner et al., THE QUARTERLY JOURNAL OF EXPERIMENTAL PSYXHOLOGY 2009, 62(8), 1457-1506) have shown that perceptual span, the capacity to integrate a certain number of letters and words in 1 single glance of a few hundred milliseconds in length, is asymmetric during reading and offset towards the right-hand side for individuals used to reading from left to right. Specifically, this acquired functional asymmetry allows anterograde reading eye movements, and therefore the point when the eyes will alight on following words, to be anticipated.

Other types of measurements may be envisioned to personalize the symmetry of the binocular visual field. Thus, it may be advantageous to take into account an asymmetry in the visual field in the case of wearers diagnosed with glaucoma and thus respect frequent asymmetries in the progression and manifestation of this pathology in each eye or even provide a specific progressive lens for attentional field asymmetries.

FIG. 8a shows cylinder gradient values for points located on either side of the near visual point of a surface of a progressive ophthalmic lens according to the prior art.

As illustrated in FIG. 8a, progressive ophthalmic surfaces according to the prior art exhibit a high symmetry in the distribution of the cylinder gradient about the near visual point.

Specifically, points located at the ordinate Yp on either side of the near visual point respect:

$$\vert \frac{{MaxgradCyl}_{Ny 1} - {MaxgradCyl}_{Ty 1}}{{MaxgradCyl}_{Ny 1} + {MaxgradCyl}_{Ty 1}} \vert = 0.056$$

where:

MaxgradCyl_{Ny1} is the absolute value of the maximum cylinder gradient of all the points located at said ordinate Yp in the nasal portion of the surface; and

MaxgradCyl_{Ty1} is the absolute value of the maximum cylinder gradient of all the points located at said ordinate Yp in the temporal portion of the surface.

FIG. 8b illustrates cylinder gradient values for points located on either side of the near visual point of a surface of a progressive ophthalmic lens according to one embodiment of the invention.

Thus, as illustrated in FIG. 8b, a progressive ophthalmic surface according to this embodiment exhibits a high asymmetry in the distribution of the cylinder gradients about the near visual point.

Specifically, in the example illustrated in FIG. 8b, points located at the ordinate Yp on either side of the near visual point respect:

$$\vert \frac{{MaxgradCyl}_{Ny 1} - {MaxgradCyl}_{Ty 1}}{{MaxgradCyl}_{Ny 1} + {MaxgradCyl}_{Ty 1}} \vert = 0.286 .$$

FIGS. 9a and 9b show sphere gradient values for points located on either side of the near visual point for a lens comprising a prior-art ophthalmic surface and a lens comprising an ophthalmic surface according to the invention, respectively.

As illustrated in FIG. 5a, the lens comprising the prior-art ophthalmic surface has a sphere gradient profile that is symmetric about the near visual point, and for points located at an ordinate Yp on either side of the near visual point:

$$0.06 \geq \vert \frac{{MaxgradSph}_{Ny 1} - {MaxgradSph}_{Ty 1}}{{MaxgradSph}_{Ny 1} + {MaxgradSph}_{Ty 1}} \vert .$$

Thus, lenses comprising the prior-art ophthalmic surfaces are poorly suited to wearers that have a span.

As illustrated in FIG. 9b, the progressive ophthalmic surface according to the invention exhibits an asymmetry in the distribution of the sphere gradient between the nasal and temporal portions.

The surface illustrated in FIG. 9b exhibits, for points located at an ordinate Yp on either side of the near visual point, a contrast in sphere gradient

$$\vert \frac{{MaxgradSph}_{Ny 1} - {MaxgradSph}_{Ty 1}}{{MaxgradSph}_{Ny 1} + {MaxgradSph}_{Ty 1}} \vert$$

equal to 0.261.

According to a preferred embodiment of the invention, the ordinate points Yp are contained inside a 50 mm diameter disc centered on the reference point O.

According to one embodiment of the invention, the contrasts in cylinder and sphere gradients of the surface may be defined depending on the difference between the right and left “eye/head” coefficient. For example, this may be a linear function giving a cylinder and sphere contrast of about 0.5 in an extreme case of total asymmetry between the left and right “eye/head” coefficients.

For example, the cylinder and sphere contrast functions may be:

$$\vert \frac{{MaxgradCyl}_{Ny 1} - {MaxgradCyl}_{Ty 1}}{{MaxgradCyl}_{Ny 1} + {MaxgradCyl}_{Ty 1}} \vert = \frac{G \times 0.5}{100} and$$

$$\vert \frac{{MaxgradSph}_{Ny 1} - {MaxgradSph}_{Ty 1}}{{MaxgradSph}_{Ny 1} + {MaxgradSph}_{Ty 1}} \vert = \frac{G \times 0.5}{100}$$

where G is the percentage difference between the left and right gain.

In one embodiment using span as an asymmetry parameter, for example for near vision, a person skilled in the art will define a linear function between a minimum span, for example of zero, and a maximum span.

As illustrated in FIG. 10, the design of a pair of surfaces according to the invention may comprise the following steps:
a step S1 of providing the prescription;
a step S2 of providing the eye/head coefficients; and
a step S3 of defining a pair of lenses comprising progressive ophthalmic surfaces.

In the step S1 of providing the prescription, the prescription of a wearer is provided.

In the step S2 of providing the eye/head coefficients, the right and left eye/head coefficients of the wearer are provided.

In the step S3 of defining a pair of lenses comprising progressive ophthalmic surfaces, a pair of lenses comprising progressive ophthalmic surfaces according to the invention is defined depending on the prescription of the wearer and the values of the cylinder contrasts:

$$\vert \frac{{MaxgradCyl}_{Ny 1} - {MaxgradCyl}_{Ty 1}}{{MaxgradCyl}_{Ny 1} + {MaxgradCyl}_{Ty 1}} \vert and$$

$$\vert \frac{{MaxgradCyl}_{Ny 2} - {MaxgradCyl}_{Ty 2}}{{MaxgradCyl}_{Ny 2} + {MaxgradCyl}_{Ty 2}} \vert$$

where

MaxgradCyl_{Ny1} and MaxgradCyl_{Ny2} are the absolute values of the maximum cylinder gradient of points located at said ordinate Yp in the nasal portion of the first and second surfaces, respectively; and

MaxgradCyl_{Ty1} and MaxgradCyl_{Ty2} are the absolute values of the maximum cylinder gradient of points located at said ordinate Yp in the temporal portion of the first and second surfaces, respectively.

According to one embodiment, the cylinder gradient contrasts may be defined, for example about the distance visual point, by means of the left and right eye/head coefficients of the wearer.

According to one embodiment of the invention, the cylinder gradient contrasts may be defined, for example about the near visual point, by means of the span of the wearer.

An existing solution allowing the eye/head coefficient of a wearer to be taken into account was developed by the Applicant. This solution consists in providing a lens tailored depending on the measured eye/head coordination coefficient, with a surface having what is called a soft distribution of sphere and cylinder gradients for wearers having a tendency to move their head a lot and what is called a hard distribution of sphere and cylinder gradients for wearers having a tendency to move their eyes a lot.

In the step S3 of defining a pair of progressive ophthalmic surfaces, it is possible to apportion this prior-art solution for example by separating the zones into four quadrants that are assumed to be independent.

Considering an extreme example, if a wearer exhibits an eye/head coefficient of 1 to the right, and a coefficient of 0 to the left, meaning that he or she does not turn their head toward the target when the latter appears in the right-hand portion of the visual field, then the progressive lens of such an individual would have a distribution of sphere and cylinder gradients of the hard type in the right-hand hemifield and of the soft type in the other hemifield.

It will be understood that the invention may be produced in forms different to those of the embodiments that were described in detail above.

The invention is not limited to the embodiments described which must be interpreted as being nonlimiting and encompassing any equivalent variants.

1. A progressive lens comprising a progressive ophthalmic surface including a main progression meridian dividing the surface into a nasal portion and a temporal portion and passing through at least one fitting point Py of ordinate Yp in a coordinate system centered on a reference point O(0; 0), characterized in that for the points located at an ordinate Yp on either side of said fitting point Py, the points of ordinate Yp being contained inside a 50 mm diameter disc centered on the reference point O:
$$0.5 \geq \vert \frac{{MaxgradCyl}_{Ny 1} - {MaxgradCyl}_{Ty 1}}{{MaxgradCyl}_{Ny 1} + {MaxgradCyl}_{Ty 1}} \vert \geq 0.2$$
where:
MaxgradCylNy1 is the absolute value of the maximum cylinder gradient of all the points located at said ordinate Yp in the nasal portion of the surface; and
MaxgradCylTy1 is the absolute value of the maximum cylinder gradient of all the points located at said ordinate Yp in the temporal portion of the surface.

2. The progressive lens comprising a progressive ophthalmic surface as claimed in claim 1, comprising a visual zone intended for distance vision, said fitting point Py is a distance vision fitting point.

3. The progressive lens comprising a progressive ophthalmic surface as claimed in claim 1, comprising a visual zone intended for near vision, said fitting point Py is a near vision fitting point.

4. The progressive lens comprising a progressive ophthalmic surface as claimed in claim 1, for which for the points located at an ordinate Yp on either side of said fitting point Py:
$$0.5 \geq \vert \frac{{MaxgradSph}_{Ny 1} - {MaxgradSph}_{Ty 1}}{{MaxgradSph}_{Ny 1} + {MaxgradSph}_{Ty 1}} \vert \geq 0.2$$
where:
MaxgradSphNy1 is the absolute value of the maximum sphere gradient of points located at said ordinate Yp in the nasal portion of the surface; and
MaxgradSphTy1 is the absolute value of the maximum sphere gradient of points located at said ordinate Yp in the temporal portion of the surface.

5. A pair of progressive lenses comprising progressive ophthalmic surfaces including a first lens comprising a first progressive surface intended for a right eye of a wearer and a second lens comprising a second progressive surface intended for a left eye of a wearer, the first and second surfaces being as claimed in claim 1 and for the points located at an ordinate Yp on either side of the point Py of each of the progressive surfaces:
$$\vert \frac{{MaxgradCyl}_{Ny 1} - {MaxgradCyl}_{Ty 2}}{{MaxgradCyl}_{Ny 1} + {MaxgradCyl}_{Ty 2}} \vert \leq 0.1 and , \\ \vert \frac{{MaxgradCyl}_{Ny 2} - {MaxgradCyl}_{Ty 1}}{{MaxgradCyl}_{Ny 2} + {MaxgradCyl}_{Ty 1}} \vert \leq 0.1$$
where:
MaxgradCylNy1 is the absolute value of the maximum cylinder gradient of all the points located at said ordinate Yp in the nasal portion of the first surface;
MaxgradCylTy1 is the absolute value of the maximum cylinder gradient of all the points located at said ordinate Yp in the temporal portion of the first surface;
MaxgradCylNy2 is the absolute value of the maximum cylinder gradient of all the points located at said ordinate Yp in the nasal portion of the second surface; and
MaxgradCylTy2 is the absolute value of the maximum cylinder gradient of all the points located at said ordinate Yp in the temporal portion of the second surface.

6. The pair of progressive lenses comprising progressive ophthalmic surfaces as claimed in claim 5, for which for the points located at an ordinate Yp on either side of said fitting point Py:
$$\vert \frac{{MaxgradSph}_{Ny 1} - {MaxgradSph}_{Ty 2}}{{MaxgradSph}_{Ny 1} + {MaxgradSph}_{Ty 2}} \vert \leq 0.1$$
$$\vert \frac{{MaxgradSph}_{Ny 2} - {MaxgradSph}_{Ty 1}}{{MaxgradSph}_{Ny 2} + {MaxgradSph}_{Ty 1}} \vert \leq 0.1$$
where:
MaxgradSphNy1 is the absolute value of the maximum sphere gradient of all the points located at the ordinate Yp in the nasal portion of the first surface;
MaxgradSphTy1 is the absolute value of the maximum sphere gradient of all the points located at the ordinate Yp in the temporal portion of the first surface;
MaxgradSphNy2 is the absolute value of the maximum sphere gradient of all the points located at the ordinate Yp in the nasal portion of the second surface; and
MaxgradSphTy2 is the absolute value of the maximum sphere gradient of all the points located at the ordinate Yp in the temporal portion of the second surface.

7. A method for defining a pair of progressive lenses comprising progressive ophthalmic surfaces including a first lens comprising a first progressive surface, the first lens being intended for a right eye of a wearer and a second lens comprising a second progressive surface, the second lens being intended for a left eye of a wearer, the method comprising:
a step of providing the prescription, in which the prescription of a wearer is provided;
a step of providing eye/head coefficients, in which the right and left eye/head coefficients of the wearer are provided;
a step of defining a pair of progressive lenses comprising progressive ophthalmic surfaces, in which a pair of lenses comprising progressive ophthalmic surfaces as claimed in claim 5 is defined depending on the prescription of the wearer and the values of
$$\vert \frac{{MaxgradCyl}_{Ny 1} - {MaxgradCyl}_{Ty 1}}{{MaxgradCyl}_{Ny 1} + {MaxgradCyl}_{Ty 1}} \vert and$$
$$\vert \frac{{MaxgradCyl}_{Ny 2} - {MaxgradCyl}_{Ty 2}}{{MaxgradCyl}_{Ny 2} + {MaxgradCyl}_{Ty 2}} \vert$$
where
MaxgradCylNy1 and MaxgradCylNy2 the absolute values of the maximum cylinder gradient of all the points located at said ordinate Yp in the nasal portion of the first and second surfaces, respectively, and
MaxgradCylTy1 and MaxgradCylTy2 the absolute values of the maximum cylinder gradient of all the points located at said ordinate Yp in the temporal portion of the first and second surfaces, respectively,
are set depending on the right and left eye/head coefficients of the wearer.

8. A method for defining a pair of progressive lenses comprising progressive ophthalmic surfaces including a first lens comprising a first progressive surface, said first lens being intended for a right eye of a wearer and a second lens comprising a second progressive surface, the second lens being intended for a left eye of a wearer, the method comprising:
a step of providing the prescription, in which the prescription of a wearer is provided;
a step of providing the span, in which the perceptual span of the wearer is provided;
a step of defining a pair of progressive ophthalmic surfaces, in which a pair of lenses comprising progressive ophthalmic surfaces as claimed in claim 5 is defined depending on the prescription of the wearer and the values of
$$\vert \frac{{MaxgradCyl}_{Ny 1} - {MaxgradCyl}_{Ty 1}}{{MaxgradCyl}_{Ny 1} + {MaxgradCyl}_{Ty 1}} \vert and$$
$$\vert \frac{{MaxgradCyl}_{Ny 2} - {MaxgradCyl}_{Ty 2}}{{MaxgradCyl}_{Ny 2} + {MaxgradCyl}_{Ty 2}} \vert$$
where
MaxgradCylNy1 and MaxgradCylNy2 the absolute values of the maximum cylinder gradient of all the points located at said ordinate Yp in the nasal portion of the first and second surfaces, respectively, and
MaxgradCylTy1 and MaxgradCylTy2 the absolute values of the maximum cylinder gradient of all the points located at said ordinate Yp in the temporal portion of the first and second surfaces, respectively,
are set depending on the perceptual span of the wearer.

9. A method for obtaining a piece of ophthalmic equipment comprising a pair of progressive lenses comprising progressive ophthalmic surfaces forming a right lens and a left lens, the method involving using the pair of lenses comprising progressive ophthalmic surfaces as claimed in claim 1 to define the optical function of a right target lens and to define the optical function of a left target lens.

10. A piece of ophthalmic equipment comprising a pair of progressive lenses comprising progressive ophthalmic surfaces, said piece of equipment being obtained according to claim 10.

11. A method for defining a pair of progressive lenses comprising progressive ophthalmic surfaces including a first lens comprising a first progressive surface, the first lens being intended for a right eye of a wearer and a second lens comprising a second progressive surface, the second lens being intended for a left eye of a wearer, the method comprising:
a step of providing the prescription, in which the prescription of a wearer is provided;
a step of providing eye/head coefficients, in which the right and left eye/head coefficients of the wearer are provided;
a step of defining a pair of progressive lenses comprising progressive ophthalmic surfaces, in which a pair of lenses comprising progressive ophthalmic surfaces as claimed in claim 6 is defined depending on the prescription of the wearer and the values of
$$\vert \frac{{MaxgradCyl}_{Ny 1} - {MaxgradCyl}_{Ty 1}}{{MaxgradCyl}_{Ny 1} + {MaxgradCyl}_{Ty 1}} \vert and$$
$$\vert \frac{{MaxgradCyl}_{Ny 2} - {MaxgradCyl}_{Ty 2}}{{MaxgradCyl}_{Ny 2} + {MaxgradCyl}_{Ty 2}} \vert$$
where
MaxgradCylNy1 and MaxgradCylNy2 the absolute values of the maximum cylinder gradient of all the points located at said ordinate Yp in the nasal portion of the first and second surfaces, respectively, and
MaxgradCylTy1 and MaxgradCylTy2 the absolute values of the maximum cylinder gradient of all the points located at said ordinate Yp in the temporal portion of the first and second surfaces, respectively,
are set depending on the right and left eye/head coefficients of the wearer.

12. A method for defining a pair of progressive lenses comprising progressive ophthalmic surfaces including a first lens comprising a first progressive surface, said first lens being intended for a right eye of a wearer and a second lens comprising a second progressive surface, the second lens being intended for a left eye of a wearer, the method comprising:
a step of providing the prescription, in which the prescription of a wearer is provided;
a step of providing the span, in which the perceptual span of the wearer is provided;
a step of defining a pair of progressive ophthalmic surfaces, in which a pair of lenses comprising progressive ophthalmic surfaces as claimed in claim 6 is defined depending on the prescription of the wearer and the values of
$$\vert \frac{{MaxgradCyl}_{Ny 1} - {MaxgradCyl}_{Ty 1}}{{MaxgradCyl}_{Ny 1} + {MaxgradCyl}_{Ty 1}} \vert and$$
$$\vert \frac{{MaxgradCyl}_{Ny 2} - {MaxgradCyl}_{Ty 2}}{{MaxgradCyl}_{Ny 2} + {MaxgradCyl}_{Ty 2}} \vert$$
where
MaxgradCylNy1 and MaxgradCylNy2 the absolute values of the maximum cylinder gradient of all the points located at said ordinate Yp in the nasal portion of the first and second surfaces, respectively, and
MaxgradCylTy1 and MaxgradCylTy2 the absolute values of the maximum cylinder gradient of all the points located at said ordinate Yp in the temporal portion of the first and second surfaces, respectively,
are set depending on the perceptual span of the wearer.
